(19) United States
(12) Patent Application Publication
(10) Pub. No.: US 2024/0204414 A1
(43) Pub. Date: Jun. 20, 2024

(54) OPTICALLY TRANSPARENT REFLECTARRAY

(71) Applicant: 3M INNOVATIVE PROPERTIES COMPANY, St. Paul, MN (US)

(72) Inventors: Ivan Lemesh, Minneapolis, MN (US); Sergei A. Manuilov, Bayport, MN (US); Michael S. Graff, Woodbury, MN (US); Kevin W. Gotrik, Hudson, WI (US); John J. Sullivan; Raymond P. Johnston, Lake Elmo, MN (US); Gregory M. Haugen, Edina, MN (US)

(21) Appl. No.: 18/287,356

(22) PCT Filed: Apr. 12, 2022
(86) PCT No.: PCT/IB2022/053410

§ 371 Date: Oct. 18, 2023

Related U.S. Application Data
(60) Provisional application No. 63/180,893, filed on Apr. 28, 2021.

(51) Int. Cl. H01Q 15/00

(52) U.S. Cl. CPC H01Q 15/0013

(57) ABSTRACT

Optically transparent reflectarray articles and methods of making and using the same are provided. The reflectarray article includes a frequency selective surface (FSS) layer and a ground plane layer disposed on opposite sides of a dielectric substrate. The FSS layer includes a pattern of wire-like resonating metallic elements configured to reflect incident mmWaves, and the ground plane layer includes a pattern of metal-based conductor mesh to provide conductivity and high visible light transmittance.

### BACKGROUND

The fifth generation technology standard (5G) for broadband cellular networks began deploying worldwide in 2019. Like its predecessors, 5G networks are cellular networks, in which the service area is divided into small geographical areas called cells. All 5G wireless devices in a cell are connected to the Internet and telephone network by radio waves through a local antenna in the cell. The main advantage of the new 5G networks is that they will have greater bandwidth, giving higher download speeds up to 10 gigabits per second (Gbit/s). The increased speed is achieved partly by using higher-frequency radio waves than previous cellular networks. The use of higher frequency radio waves in the 6 GHz to 100 GHz spectrum region, referred heretofore as microwaves or millimeter waves, or mm Waves, has been identified for small cell backhaul and wireless access. The higher-frequency radio waves have a shorter useful physical range, requiring smaller geographic cells. Line-of-Sight (LOS) links using highly directional antennas with high gain provide a focused beam directly to the mobile user. The LOS connection is used to compensate for the higher path loss and signal degradations at mmWave frequencies.

Beam steering of radiofrequency (RF) waves for LOS connection is becoming an indispensable part of modern wireless communications now that the frequency of mobile network providers is getting well into the mmWave regime. At higher frequencies, the propagation losses typically increase, while the reflections from objects (building walls, window glass, metal surfaces) become either poor (e.g., due to losses) or just inefficient (e.g., representing diffuse or specular scatterings), which results in a large number of dead zones. This issue is typically resolved by introducing more towers or active phase repeat antennas, which may not be cost-effective.

### SUMMARY

There is a desire to provide cost-effective solutions for beam steering of radiofrequency (RF) waves in wireless communications. In one aspect, the present disclosure provides an optically transparent reflectarray article including a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure; a ground plane layer including a patterned conductor formed by a plurality of traces defining cells of a continuous metallic mesh disposed on a major surface thereof; and one or more dielectric layers sandwiched between the FSS layer and the ground plane layer. The article is substantially optically transparent in a free-space wavelength range from about 380 nm to about 700 nm.

In another aspect, the present disclosure provides a method of making an optically transparent reflectarray article. The method includes providing a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure; providing a ground plane layer comprising a patterned conductor formed by a plurality of traces defining cells of a continuous metallic mesh disposed on a major surface thereof; and providing one or more dielectric layers sandwiched between the FSS layer and the ground plane layer. The article is substantially optically transparent in a free-space wavelength range from about 380 nm to about 700 nm.

### BRIEF DESCRIPTION OF THE DRAWINGS

FIG. 1 is a cross-sectional view of an optically transparent reflectarray film, according to one embodiment.

FIG. 2 is a cross-sectional view of an optically transparent reflectarray film, according to another embodiment.

FIG. 3A is a schematic plan view of a pattern of resonating metallic elements, according to some embodiments.

FIG. 3B is a schematic close-up view of a pattern of resonating metallic elements and a metallic mesh, according to some embodiments.

FIG. 4 is a top plan view of an illustrative geometry of an electrically conductive pattern, according to one embodiment.

FIG. 5 is a schematic diagram of an outdoor application of an optically transparent reflectarray film, according to one embodiment.

FIG. 6 is a schematic diagram of an indoor application of an optically transparent reflectarray film, according to one embodiment.

FIG. 7A is a plot of reflected amplitude as a function of frequency from simulated reflection curves for a reflectarray film.

FIG. 7B is a plot of phase as a function of frequency from simulated reflection curves for the reflectarray film.

FIG. 7C is a plot of reflected phase and amplitude as a function of ring diameter at 30 GHz.

FIG. 7D is a plot of the reflected angle as a function of the phase gradient.

FIG. 7E is a plot of the required phase variation for a chosen 60° beam steering functionality.

FIG. 7F is a schematic diagram of a desired pattern of resonating metallic elements.

FIG. 7G is a contour plot of the reflected beam strength (E-field) as a function of spherical angle.

FIG. 7H is a plot of the reflected beam strength (E-field) as a function of polar angle.

FIG. 7I is a plot of the reflected beam strength (E-field) as a function of azimuthal angle.

FIG. 8A is a schematic cross-sectional view of the reflectarray film of Example 1.

FIG. 8B is a schematic cross-sectional view of the reflectarray film of Example 2.

FIG. 9 is a schematic diagram of a characterization setup.

FIG. 10 is a plot of reflection spectrum as a function of frequency for the reflectarray film of Example 1 and for aluminum foil.

FIG. 11A is a plot of scattering curves for the reflectarray film of Example 1 and for aluminum foil at 30 GHz for normal incidence.

FIG. 11B is a plot of reflectance curves for the reflectarray film of Example 1 and for aluminum foil at 30 GHz in a specular reflection geometry.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides cost-effective solutions for beam steering of radiofrequency (RF) waves in wireless communications. An optically transparent reflectarray article is provided for beam steering of radiofrequency (RF) waves. The optically transparent reflectarray article includes a frequency selective surface (FSS) layer including a pattern of resonating metallic elements configured to reflect an incident radiofrequency (RF) electromagnetic wave at a free-space wavelength λ in a range from about 1.0 mm to about 10.0 cm, each resonating metallic element including a wire-like structure; a ground plane layer including a patterned conductor formed by a plurality of traces defining cells of a continuous metallic mesh disposed on a major surface thereof; and one or more dielectric layers sandwiched between the FSS layer and the ground plane layer. The article is substantially visible-light transparent in a free-space wavelength range from about 380 nm to about 700 nm. The substantially optically transparent reflectarray article described herein may be in any desirable structures such as, for example, a film.

Methods of making an optically transparent reflectarray article (e.g., a film) are provided. The methods include providing a frequency selective surface (FSS) layer including a pattern of resonating metallic elements configured to reflect an incident radiofrequency (RF) electromagnetic wave at a wavelength λ in a range from about 1.0 mm to about 10.0 cm, each resonating metallic element including a wire-like structure; providing a ground plane layer including a patterned conductor formed by a plurality of traces defining cells of a continuous metallic mesh disposed on a major surface thereof; and providing one or more dielectric layers sandwiched between the FSS layer and the ground plane layer.

As used herein, the term “reflectarray” refers to a planar array of phase shifting elements backed up by a ground plane that, when illuminated by a feeding antenna (which can be nearby or far way, stationary or moving), reflects its RF radiation in a certain direction (or redistributes to multiple directions).

As used herein, the term “resonating metallic elements” or “phase shifting elements” refers to the elementary building blocks of reflectarray that resonate in the presence of radio frequency (RF) radiation, with their phase characteristics dependent on their dimensions (geometry).

As used herein, the term “beam steering” refers to the static property of reflect arrays to redirect an incident RF radiation by a certain desired amount (i.e., without dynamic tunability).

Unless otherwise indicated, the terms “transparent”, “optically transparent”, “substantially transparent”, “quasi transparent” are used interchangeably and refer to an article, a film, a polymeric material, or an adhesive that has a high light transmittance (e.g., at least 50 percent, at least 55 percent, at least 60 percent, at least 65 percent, at least 70 percent, at least 75 percent, or at least 80 percent) over at least a portion of the visible light spectrum (about 400 to about 700 nanometers (nm)). In many embodiments, the high transmittance is over the entire visible light spectrum.

As used herein, the term “polymer” refers to a polymeric material that is a homopolymer, copolymer, terpolymer, or the like. As used herein, the term “homopolymer” refers to a polymeric material that is the reaction product of a single monomer. As used herein, the term “copolymer” refers to a polymeric material that is the reaction product of two different monomers and the term “terpolymer” refers to a polymeric material that is the reaction product of three different monomers.

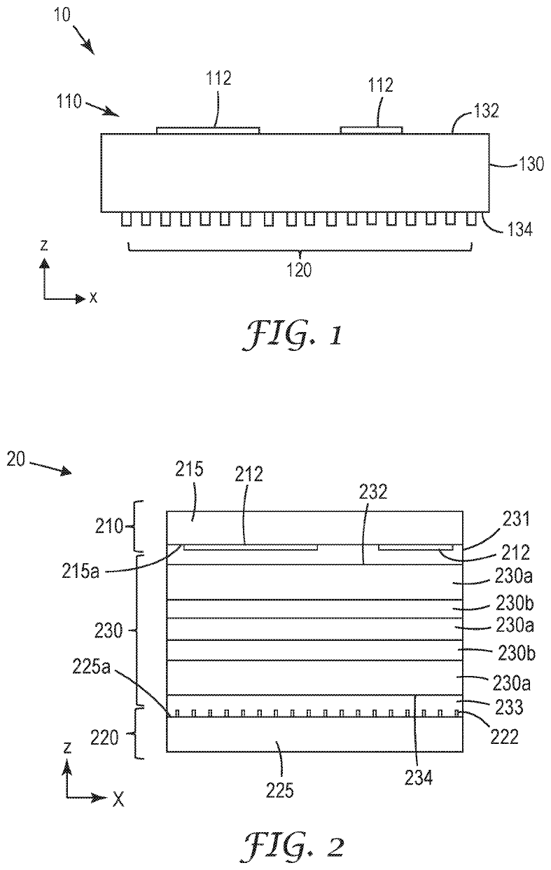

FIG. 1 is a cross-sectional view of an optically transparent reflectarray film 10, according to one embodiment. The optically transparent reflectarray film 10 includes a frequency selective surface (FSS) layer 110 disposed on a first major surface 132 of a dielectric layer 130. A ground plane layer 120 is disposed on a second major surface 134 of the of dielectric layer 130. The ground plane layer 120 includes a patterned conductor formed by a plurality of traces defining cells of a continuous metallic mesh.

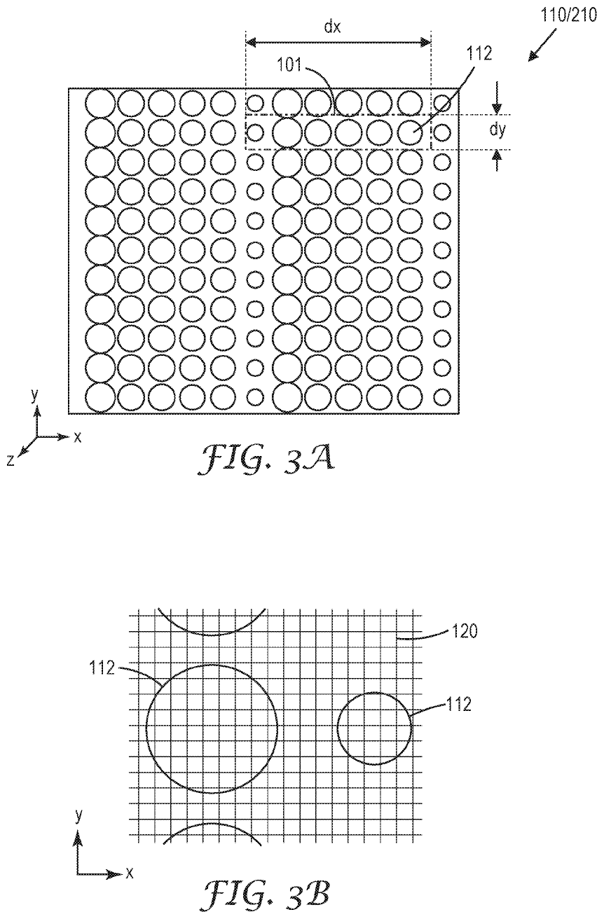

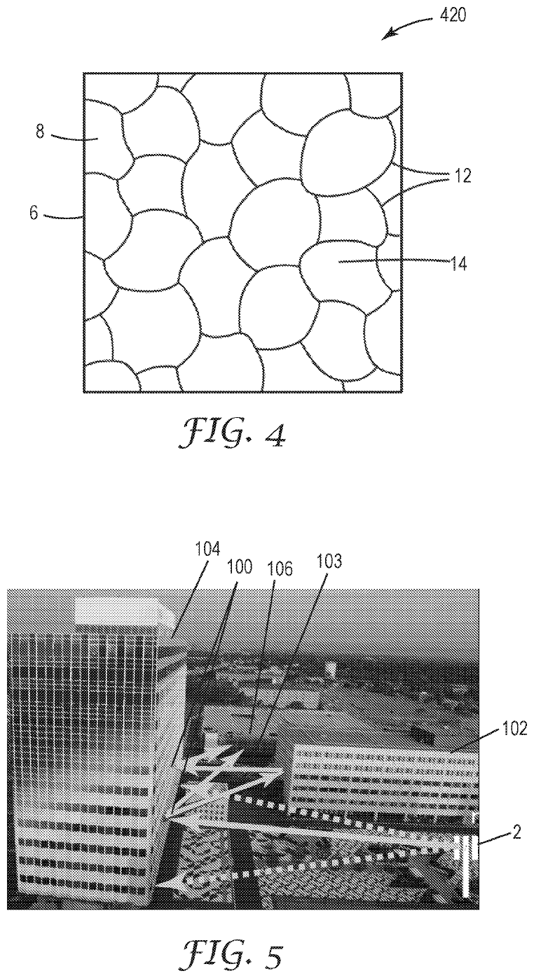

The FSS layer 110 includes a pattern of resonating metallic elements configured to reflect incident microwaves or millimeter waves which can be a radiofrequency (RF) electromagnetic wave at a free-space wavelength λ in a range from about 1.0 mm to about 10.0 cm. FIG. 3A is a schematic plan view of a pattern of resonating metallic elements, according to some embodiments. The pattern of resonating metallic elements can be a metastructure including a two dimensional array of repeating unit cells (e.g., the repeating unit cell 101 in FIG. 3A).

In the embodiment depicted in FIG. 3A, the repeating unit cell 101 includes multiple phase-shifting elements 112. The unit cell 101 has a dimension dx in the x axis and a dimension dy in the y axis. The resonating metallic elements 112 are arranged to be periodic in at least one axis, such as the x-axis. In this embodiment, the repeating unit cell 101 includes six alternating phase shifting elements (only two of the six phase shifting elements are shown in FIG. 3B). It is to be understood that a repeating unit cell may include any suitable number of alternating phase shifting elements. A repeating unit cell may include, for example, 1, 2, 3, 4, 5, 6, 7, 8, or more phase shifting elements. When the number of phase shifting elements in a unit cell is one, the performance of the FSS layer may reduce to a mirror-like performance (specular). When the number of phase shifting elements in a unit cell is two or three, it might be difficult for the FSS layer to properly steer an incident RF beam, where instead of obtaining one reflected beam, the pattern of phase shifting elements may generate lots of scatterings in different directions. The RF reflection performance of a FSS layer may depend on the dimensions dx/m and dy/n, where m is the number of phase shifting elements in a unit cell in the x axis, and n is the number of phase shifting elements in a unit cell in the y axis. For example, in the embodiment of FIG. 3A, m=6, and n=1. In the present disclosure, suitable dimensions dx/m and dy/n can be chosen such that λ/10<dy/m<λ, and λ/10<dx/n<λ, where λ is the free-space wavelength of a frequency of operation, i.e., the free-space wavelength of the wave incident on the reflectarray film.

To act as phase shifting elements, the resonating metallic elements may include an array of periodic metastructures of suitable shapes. In the embodiments of FIGS. 3A-B, the phase shifting elements each have a ring shape. It is to be understood that a phase shifting element may include other shaped structures such as, for example, a “cross” or “plus sign” shaped structure, a “cross” structure disposed in the central region of a ring, a triangle shape, etc.

Each resonating metallic element can have a wire-like structure, which can be formed by providing one or more metallic materials on the first major surface 132 of the dielectric layer 130. The resonating metallic elements each may have a two dimensional geometric structure with a lateral dimension no greater than λ, where λ is the free-space wavelength of a frequency of operation, i.e., the free-space wavelength of the wave incident on the reflectarray film. The resonating metallic elements each may have a lateral dimension in a range, for example, from about 10 to about 10,000 micrometers. The resonating metallic elements each may have a line width in a range, for example, from about 1.0 to about 50.0 micrometers, and a thickness several times of the skin depth thickness of selected metal within operating frequency range. The thickness may be in a range, for example, from about 0.02 to about 100 micrometers. The resonating metallic elements each have an aspect ratio of line-width versus thickness, for example, in a range from 0.1 to 2500.

The dielectric substrate 130 can be formed from a flexible film or rigid substrate. The second major surface 132 of the dielectric layer 130 has a ground plane layer 120 formed thereon. The dielectric layer 130 is sandwiched between the FSS layer 110 and the ground plane layer 120. The dielectric layer 130 may include an optically transparent polymer including, for example, at least one of polyethylene terephthalate (PET), polyethylene naphthalate (PEN), acrylic-, butyrate-, polycarbonate, polycarbonate copolymers, polyethersulfone, polyethylene terephthalate glycol-modified (PETG), etc. It is to be understood that the dielectric layer 130 may include any suitable inorganic transparent dielectric material such as, for example, glass.

The ground plane layer 120 includes a patterned conductor formed by a plurality of traces defining cells of a continuous metallic mesh disposed on the second major surface 134 of the dielectric substrate 130. The traces of the metallic mesh have a line width in a range, for example, from about 1.0 to about 50.0 micrometers, and a thickness in a range, for example, from 0.02 to 100.0 micrometers. In some embodiments, the traces have an aspect ratio of line-width versus thickness in a range, for example, from 0.1 to 2500. The patterned conductor has a sheet resistance no greater than about 1000 ohms per square.

The continuous metallic mesh has an open area fraction no less than about 50%, no less than about 55%, or no less than about 60%. As used herein, the term “open area fraction” (or open area or percentage of open area) of a conductor micropattern, or region of a conductor micropattern, refers to the proportion of the micropattern area or region area that is not shadowed by the conductor. An open area (e.g., a visible light transparent region) is equal to one minus the area fraction that is shadowed by the conductor pattern, and may be expressed conveniently, and interchangeably, as a decimal or a percentage. Area fraction that is shadowed by conductor pattern is used interchangeably with the density of a conductor pattern (e.g., density of traces that define a mesh).

It is to be understood that an electrically conductive pattern of a ground plane layer can have any suitable geometries. In some embodiments, an electrically conductive pattern can include, for example, dots, traces, filled shapes, or combinations thereof. The patterned conductor is formed by a plurality of conductor traces defining cells of a continuous metallic mesh disposed on a major surface of a dielectric layer. A mesh is typically understood to mean a pattern geometry having connected traces that are separated by open area to form cells. The electrically conductive traces 12 can be linear or non-linear. Illustrative examples of meshes with linear traces include those having hexagonal and square cells. An exemplary pattern of non-linear traces is illustrated in FIG. 5.

FIG. 5 shows a top plan view of an illustrative geometry of an electrically conductive pattern 420 disposed on a major surface 8 of a dielectric substrate 6, according to some embodiments. The electrically conductive pattern 420 includes a plurality of electrically conductive curved traces 12 defining a plurality of open area cells 14. The electrically conductive traces 12 can be formed on the major surface 8 of the dielectric substrate 6. In the embodiment of FIG. 5, the geometry of the metal mesh includes cells 14 defined by the conductive traces 12.

A conductor pattern described herein, such as a pattern of resonating metallic elements on a major surface of a dielectric substrate, and a continuous metallic mesh on the opposite surface of the dielectric substrate, can be prepared using any suitable method. Examples of useful metals for forming the electrically conductive micropattern include, for example, gold, silver, palladium, platinum, aluminum, copper, molybdenum, nickel, tin, tungsten, alloys, and combinations thereof. Optionally, the conductor can also be a composite material, for example a metal-filled polymer. Examples of methods for preparing conductor patterns include subtractive or additive methods. Exemplary subtractive methods include placement of a patterned mask on a metallic coating disposed on a substrate (e.g., a visible light transparent substrate), followed by selective etching (with metal being removed from regions of the metallic coating that are not covered by the mask, and with metal remaining in regions of the metallic coating that are covered by the mask). Suitable masks include photoresist (patterned by photolithography, as is known in the art), printed polymers (patterned by, for example, gravure, flexographic, or inkjet printing), or printed self-assembled monolayers (for example, printed using microcontact printing with an elastomeric relief stamp). Other exemplary subtractive methods include initial placement of a patterned lift-off mask on a substrate (e.g., a visible light transparent substrate), blanket coating of masked and unmasked regions with a metallic conductor (e.g., thin film metal), and washing of the lift-off mask and any metal disposed thereon. Exemplary additive processes include printing of electroless deposition catalyst on a substrate (e.g., visible light transparent substrate) in the form of the desired pattern geometry, followed by patterned electroless metal deposition (e.g., copper or nickel).

The methods used herein (e.g., microcontact printing) for generating a conductor pattern (e.g., a continuous metallic mesh of a ground plane layer) were found to be particularly well-suited for combination with a patterning approach based on microcontact printing and etching, thus enabling specific metallic pattern design parameters (e.g., metal trace width in a range from about 1.0 to about 50.0 micrometers, and a thickness in a range from 0.02 to 100.0 micrometers) to be fabricated such that the open area fraction of the metallic mesh can be increased to increase visible light transmittance of the device without substantially reducing the electrical conductance of the ground plane layer. The conventional methods (e.g., using ultrathin layers of metal, or rigid transparent conductive films as the ground plane layer) may not be effective for substantially increasing visible light transmittance without also substantially reducing the electrical conductance of the layer.

FIG. 2 is a cross-sectional view of an optically transparent reflectarray film 20, according to another embodiment. FIG. 3 is a schematic plan view of the optically transparent reflectarray film 20. The optically transparent reflectarray film 20 includes a frequency selective surface (FSS) layer 210 disposed on a first major surface 232 of a dielectric substrate 230. A ground plane layer 220 is disposed on a second major surface 234 of the dielectric substrate 230 opposite the FSS layer 210. The dielectric substrate 230 includes multiple layers 230a of optically transparent polymer including, for example, at least one of polyethylene terephthalate (PET), polyethylene naphthalate (PEN), acrylic-, butyrate-, polycarbonate, polycarbonate copolymers, polyethersulfone, or polyethylene terephthalate glycol-modified (PETG). The adjacent layers of polymer 230a are laminated via an optically clear adhesive (OCA) 230b to form the dielectric substrate 230. It is to be understood that the dielectric substrate can include any desired layers (e.g., one or more) of polymer material 230a. In some embodiments, the dielectric substrate can include a multilayer-construction to impart any desirable properties into the construction such as, for example, mechanical strength, color tinting, UV filtering, shrink fit characteristics, adhesive for attaching the film, corrosion resistance, chemical resistance, case of cleaning, etc.

The FSS layer 210 includes a flexible skin layer 215, and a pattern of resonating metallic elements 212 and 214 is disposed on an inner surface 215a of the flexible skin layer 215. The FSS layer 210 is laminated to the first major surface 232 of the dielectric substrate 230 via an optically clear adhesive (OCA) 231, with the pattern of resonating metallic elements 212 being sandwiched between the flexible skin layer 215 and the first major surface 232 of the dielectric substrate 230. In some embodiments, the pattern of resonating metallic elements 212 can be formed on the first major surface 232 of the dielectric substrate 230. Then a skin layer, a hardcoat layer or an encapsulating layer 215 can be laminated on the first major surface 232 of the dielectric substrate 230 via the optically clear adhesive (OCA) 231.

The ground plane layer 220 includes a flexible layer 225, and a metallic mesh 222 is disposed on an inner surface 225a of the flexible layer 225. The ground plane layer 220 is laminated to the second major surface 234 of the dielectric substrate 230 via an optically clear adhesive (OCA) 233, with metallic mesh 222 being sandwiched between the flexible layer 225 and the second major surface 234 of the dielectric substrate 230. In some embodiments, the pattern of metallic mesh 222 can be formed on the second major surface 234 of the dielectric substrate 230. Then a skin layer, a hardcoat layer or an encapsulating layer 225 can be laminated on the second major surface 234 of the dielectric substrate 230 via the optically clear adhesive (OCA) 233. The skin layer, hardcoat layer, or encapsulating layer 215, 225 can include one or more substantially transparent polymer materials the same as or different from the dielectric substrate 230. The skin layer, hardcoat layer, or encapsulating layer may include an attaching adhesive layer on one side and an anti-corrosion layer on the other side.

In some embodiments, a tie layer can be disposed between the metallic mesh and the major surface of the dielectric substrate. The tie layer may include at least one of chromium, chromium oxide, nickel chromium oxide, or combinations thereof.

A reflectarray film described herein is substantially visible light transparent. In other words, a reflectarray film including a dielectric substrate and a metallic pattern on each side of the dielectric substrate, as a whole, is at least 60 percent, at least at least 70 percent, or at least 80 percent transmissive to an incident visible light in a free-space wavelength range from about 380 nm to about 700 nm. It is within the meaning of visible light transparent for a reflectarray film that transmits at least 60 percent of incident light to include metallic patterns (e.g., a pattern of resonating metallic elements of a FSS layer, a metal-based conductor mesh of a ground plane layer) that block light locally to less than 60 percent transmission (e.g., 0 percent); however, in such cases, for an approximately equiaxed area including the metallic patterns and measuring 1000 times the minimum dimension of the metallic patterns in width (e.g., trace width), the average transmittance is greater than 60 percent, greater than 70 percent, or greater than 80 percent. The term “visible” in connection with “visible light transparent” is modifying the term “light,” so as to specify the wavelength range of light for which the dielectric substrate or the reflectarray film is substantially visible light transparent.

The reflectarray films of this disclosure can be incorporated into a wide variety of commercial articles or applications for beam steering of radiofrequency (RF) waves in wireless communications. In basic operation, a reflectarray film is illuminated by an incident wave. The wave induces current on the resonating metallic or phase shifting elements of a frequency selective surface (FSS) layer. Each phase shifting element re-radiates a secondary wave, albert with a designed phase shift. The secondary waves emanating from each of the resonating metallic or phase shifting elements will interfere to produce a primary beam pointing to a direction for which the reflectarray film is designed, based on the properties of wavefront phase manipulation to create constructive interference in a given direction.

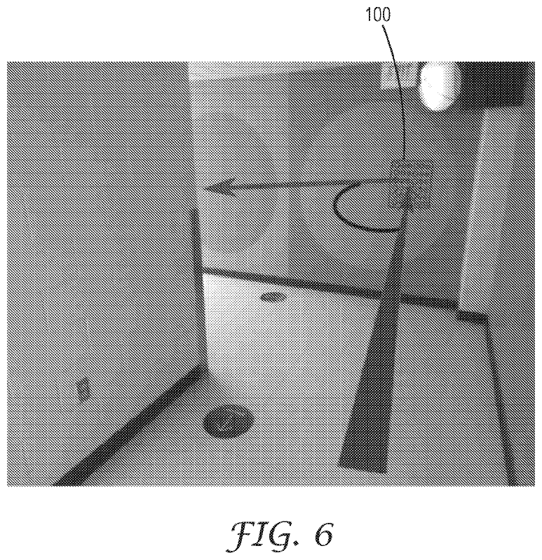

FIG. 5 is a schematic diagram of an outdoor application of an optically transparent reflectarray film, according to one embodiment. FIG. 6 is a schematic diagram of an indoor application of an optically transparent reflectarray film, according to another embodiment. A wireless base station 2 (e.g., a “5G” tower) transmits and receives wireless signals from mobile devices within its coverage area. The coverage area may be disrupted or blocked by buildings or other structures in the environment, thereby affecting the quality of the wireless signals. In the illustrated example of FIG. 5, buildings 102 and 104 may affect the coverage area of base station 2 such that there is a Non-Line-of-Sight (“NLOS”) zone 103 where users of devices may have either no wireless access, significantly reduced coverage, or impaired coverage of some sort. Wireless coverage can be improved to users in the NLOS zone 103 by the installation of one or more optically transparent or a quasi-transparent reflectarray films 100 on glass windows of building 104. The reflectarray film 100 can act as a robust and low cost relay that is positioned as illustrated between the 5G tower 2 and a user equipment (“UE”) (e.g., a UE in building 102, 106) to optimize network coverage. As illustrated in FIGS. 5 and 6, the reflectarray film 100 is formed, placed, configured, embedded, or otherwise connected to a portion of building 104, such as its glass windows, or indoor walls. Users in the Non-Line-of-Sight (“NLOS”) zone 103 are able to receive wireless signals from the BS 100 that are reflected off the reflectarray films 100.

Conventional metallic mirrors are also used for passive repeater devices when the line of sight (“LOS”) is obstructed. These metallic mirror repeater devices can redirect a narrow beam to a NLOS zone. A drawback of these metallic mirrors used as microwave relay/repeater is that the angle of incidence is equal to the angle of reflection. Accordingly, conventional microwave passive repeaters are not well suited for situations in which the angle of incidence needs to be different from the reflection angle.

In the present disclosure, a phase shift provided by a respective phase shifting element at a given position in the FSS layer can be selected such that the array of phase shifting elements redirects the beam of microwave radiation from an input angle to a desired output angle. The reflection phase response of the phase shifting element varies from 0 to a minimum of π when a size characteristic of the phase shifting element (e.g., a geometric parameter of the phase shifting element) changes. For example, a reflectarray film described herein can provide a device that reflects microwave radiation at an angle different from the specular angle (in other words, the repeater device is a non-specular reflector). The reflectarray films can be utilized in applications where it is desirable to have the ability to tune the direction of the reflected beam to the desired angle.

To obtain the desired reflection properties of a reflectarray article, an array of spatially arranged features (i.e., phase shifting elements) can be provided that are phase shifted as a function of location in such a way that the interference of all reradiated waves results in the desired (far-field) beam characteristics. There are two parts in such design: 1) the relation of feature geometry/dimension to its phase shift response and 2) the relation of the spatial phase shift distribution to the desired beam steering characteristics.

The first step can be accomplished with any electromagnetic simulation software (e.g., CST Studio Suite Software), wherein for given material parameters (dielectric permittivity, losses, thickness) one can extract the phase shift response of a single feature (that is grounded and coupled to an infinite array of the same features, i.e., using the so-called Floquet boundary conditions) as a function of feature geometry. Typically, 0 to about 300 phase spread is sufficient but larger phase sweeps can be achieved when more complex multielement features are used, which can lead to improved characteristics such as a larger bandwidth. See, for example, repeater devices described in U.S. patent application Ser. No. 16/475,165 (to Yemelong et al., Atty. Docket No. 77556US004), which is incorporated herein by reference. When the mapping from feature geometry to phase shift response is determined, an array (in the x and y direction) of elements can be built to create a certain phase shift distribution.

The second step, in general, has no specific recipes. Depending on the complexity of the desired beam steering functionality (e.g., multiple reflected angles, complex beam profiles, lensing), this might require using FFT-type approaches that lead to very complex pattern arrangements. However, for scenarios such as when the plane-wave (generated by a distant feed) needs to be merely redirected, one can then design the so-called constant phase gradient metasurfaces. All such structures follow the Generalized Snells law that connects a phase shift variation to the desired beam steering performance. This approach (such as used for Examples 1, 2 to be described further below) results in feature arrangements that are similar to the ones depicted in FIG. 3A.

Various embodiments are provided that are reflectarray films, portions of the reflectarray films, methods of making at least a portion of the reflectarray films, and methods of using the reflectarray films.

Embodiment 1 is an optically transparent reflectarray article comprising:
a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure;
a ground plane layer comprising a patterned conductor formed by a plurality of traces defining cells of a continuous metallic mesh disposed on a major surface thereof; and
one or more dielectric layers sandwiched between the FSS layer and the ground plane layer,
wherein the article is substantially optically transparent in a free-space wavelength range from about 380 nm to about 700 nm.
   Embodiment 2 is the article of embodiment 1, wherein the resonating metallic elements each have a lateral dimension no greater than the free-space wavelength 2.
   Embodiment 3 is the article of embodiment 2, wherein the resonating metallic elements each have a lateral dimension in a range from about 10 to about 10,000 micrometers.
   Embodiment 4 is the article of any one of embodiments 1-4, wherein the resonating metallic elements each have a line width in a range from about 1.0 to about 50.0 micrometers.
   Embodiment 5 is the article of embodiment 4, wherein the resonating metallic elements each have an aspect ratio of line-width versus thickness in a range from 0.1 to 2500.
   Embodiment 6 is the article of any one of embodiments 1-5, wherein the resonating metallic elements comprises an array of periodic metastructures, optionally, comprising at least one of rings, or crosses.
   Embodiment 7 is the article of any one of embodiments 1-6, wherein the traces of the metallic mesh have a line width in a range from about 1.0 to about 50.0 micrometers.
   Embodiment 8 is the article of embodiment 7, wherein the traces have an aspect ratio of line-width versus thickness in a range from 0.1 to 2500.
   Embodiment 9 is the article of any one of embodiments 1-8, wherein the continuous metallic mesh has an open area fraction no less than about 50%, no less than about 55%, or no less than about 60%.
   Embodiment 10 is the article of any one of embodiments 1-9, wherein the patterned conductor has a sheet resistance no greater than about 1000 ohms per square.
   Embodiment 11 is the article of any one of embodiments 1-10, wherein the FSS layer further comprises a flexible skin layer, and the pattern of resonating metallic elements is disposed between the skin layer and the one or more dielectric layers.
   Embodiment 12 is the article of embodiment 11, wherein the flexible skin layer has a thickness in a range from about 10 to about 500 micrometers.
   Embodiment 13 is the article of embodiment 11 or 12, wherein the flexible skin layer comprises a hardcoat layer or a polymeric encapsulating layer.
   Embodiment 14 is the article of any one of embodiments 1-13, wherein the ground plane layer comprises a flexible layer, and the metallic mesh is disposed on an inner surface of the flexible layer.
   Embodiment 15 is the article of embodiment 14, wherein the flexible layer has a thickness in a range from about 10 to about 500 micrometers.
   Embodiment 16 is the article of any one of embodiments 1-15, wherein the ground plane layer further comprises a tie layer disposed between the metallic mesh and the major surface thereof, the tie layer comprising at least one of chromium, chromium oxide, nickel chromium oxide, or combinations thereof.
   Embodiment 17 is the article of any one of embodiments 1-16, wherein the one or more dielectric layers comprise an optically transparent polymer, optionally, the polymer comprising at least one of polyethylene terephthalate (PET), polyethylene naphthalate (PEN), acrylic-, butyrate-, polycarbonate, polycarbonate copolymers, polyethersulfone, or polyethylene terephthalate glycol-modified (PETG).
   Embodiment 18 is the article of any one of embodiments 1-17, wherein the one or more dielectric layers have a thickness in a range from about 10 to about 1000 micrometers.
   Embodiment 19 is the article of any one of embodiments 1-18, wherein the FSS layer and the ground plane layer are laminated to the one or more dielectric layers via an optically clear adhesive (OCA).
   Embodiment 20 is the article of any one of embodiments 1-19, which has a thickness no less than about 50 micrometers.
   Embodiment 21 is a method of making an optically transparent reflectarray article, the method comprising:
providing a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure;
providing a ground plane layer comprising a patterned conductor formed by a plurality of traces defining cells of a continuous metallic mesh disposed on a major surface thereof; and
providing a dielectric substrate comprising one or more dielectric layers sandwiched between the FSS layer and the ground plane layer,
wherein the article is substantially optically transparent in a free-space wavelength range from about 380 nm to about 700 nm.
   Embodiment 22 is the method of embodiment 21, wherein providing the FSS layer comprises forming the pattern of resonating metallic elements on a flexible skin layer, and laminating the flexible skin layer on the dielectric substrate.
   Embodiment 23 is the method of embodiment 21 or 23, wherein providing the ground plane layer comprises forming the metallic mesh on a flexible layer, and laminating the flexible layer on the dielectric substrate.

### EXAMPLES

These examples are merely for illustrative purposes and are not meant to be limiting on the scope of the appended claims.

### Modeling Process

A three-step modeling process was utilized to model reflectarray articles, including (i) performing preliminary electromagnetic simulations with the CST Studio Suite Software (commercially available from Dassault Systèmes Company, WALTHAM, MA, U.S.A.), (ii) application of Ray optics approximation theory (see, Ö. Özgecan, et al., IEEE Wireless Communications Letters 9.5, (2019)), and (iii) the verification of far field performance using a reflect array theory (see, J. Huang, “Reflectarray Antennas”, IEEE (2007)).

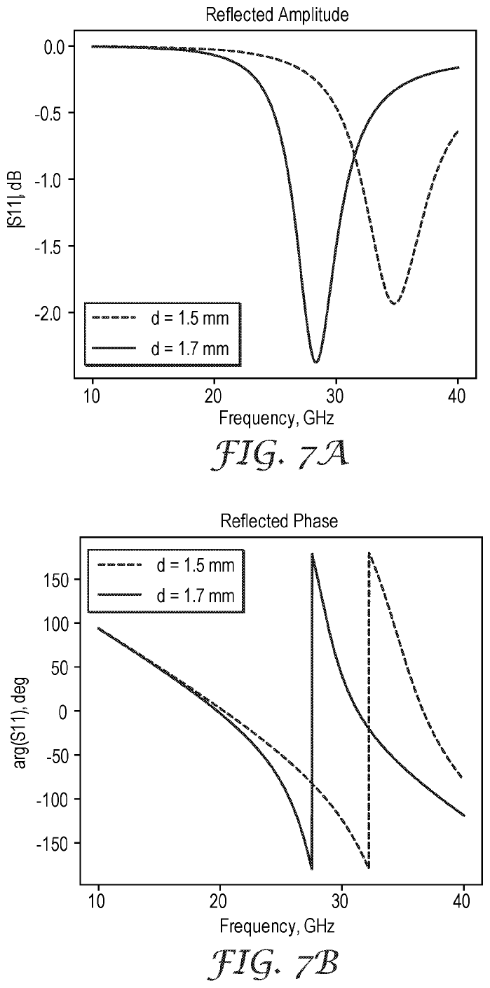

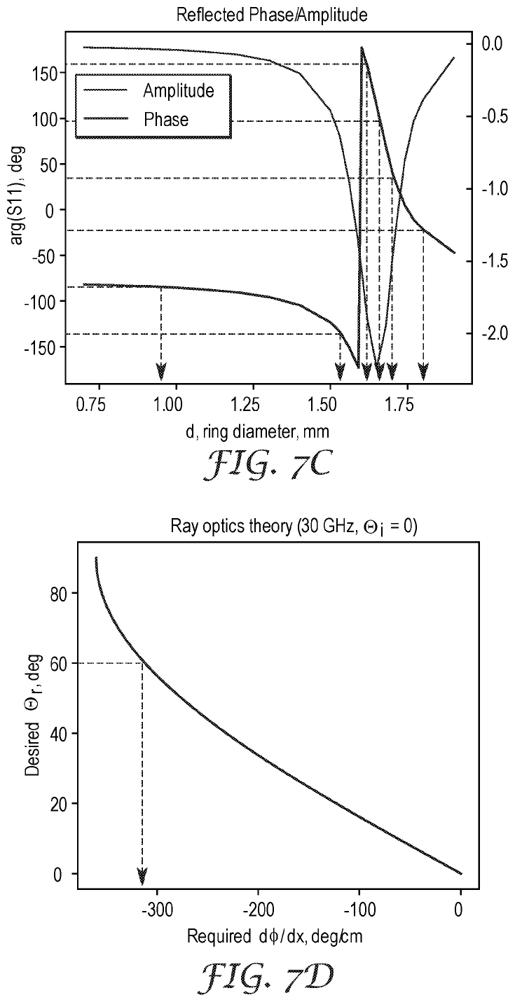

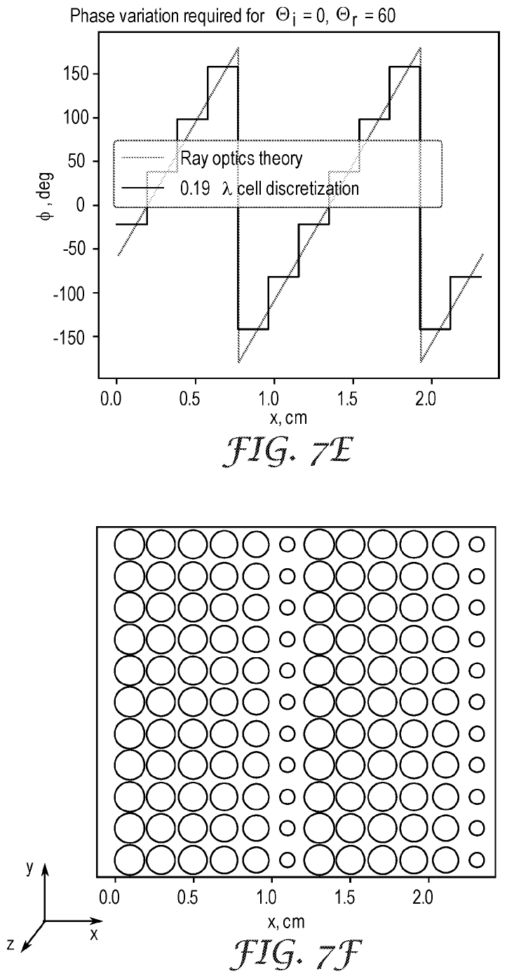

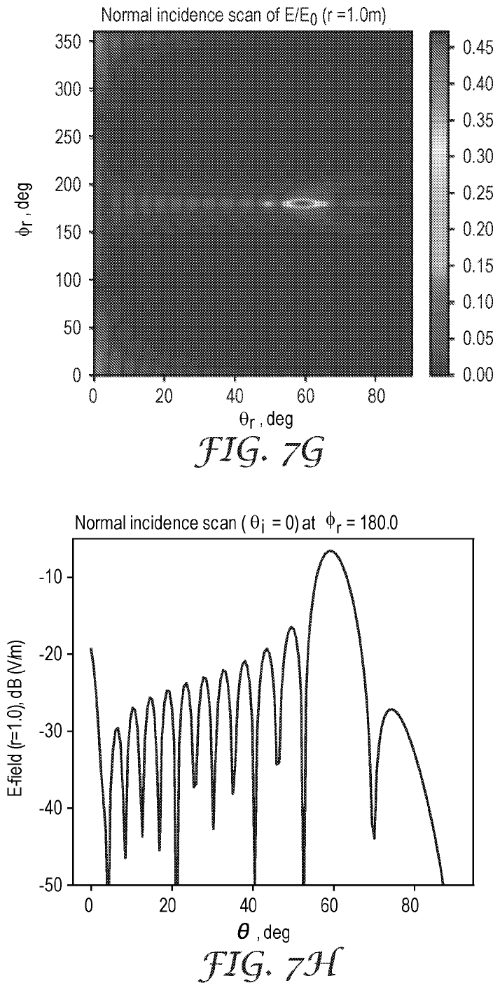

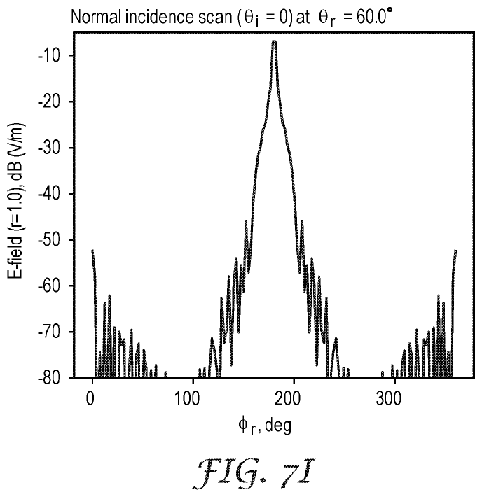

The modeling process typically starts from choosing an appropriate geometry for resonating structures (e.g., the metallic rings in FIG. 3A or 3B), for which one needs to deduce modeling parameters as a function of structure dimensions. This is typically done with numerical electromagnetic solvers, using which one can evaluate the performance of a (grounded) single element placed in periodic boundary conditions (more specifically, the Floquet boundary conditions). For example, in FIGS. 7A-B, the typical amplitude and phase curves were depicted as a function of frequency for rings with diameters of D=1.5 mm and D=1.7 mm (both have the width of 40 micrometers and the repetition period of 1.925 mm). Both resonances are in the proximity of about 30 GHz, where the structure behaves as an absorber. This is due to the creation of multiple reflections between the FSS pattern and metal ground coupled with finite losses in dielectric, which result in the signal attenuation. Note that the resulting phase sweep is about 325°, which is slightly smaller than an often desired full 360° sweep but it is still sufficient for a phase discretization given by this sample (60° per cell). Once the dimension scan is competed, the frequency of choice (30 GHz in this case) can be selected and the resulting reflection curves ca be plotted as a function of ring diameter (FIG. 7C). This curve represents the key mapping required for making a final pattern design.

For the next step, the classical Ray optics theory approximation can be applied in order to find an appropriate surface phase profile for a chosen reflected beam angle. FIG. 7D shows the underlying relation between the reflected angle and the phase gradient. For 0 to 60° steering, this corresponds to a phase gradient of −311.7°/cm. For 30 GHz frequency, this results in the surface profile depicted in FIG. 7E which shows the required phase variation for a chosen 60° beam steering functionality. Linking these values with diameter mapping given by FIG. 7C yields a final ring pattern design as shown in FIG. 7F. Note that for this sample a cell period of about λ/5 was chosen. Smaller rings would lead to a finer discretization of the curve in FIG. 7E; although in this case, the resulting structure becomes more intolerant to fabrication errors.

The final step is to verify the far field functionality of the designed device. One way to accomplish it is to use modeling parameters given by full-scale far-field electromagnetic simulations (e.g., the CST simulation in step (i)) for individual elements and apply them to a numerical reflect array theory. The corresponding numerical script can be programmed and the resulting |Eφ| values for a reflected signal are depicted in FIGS. 7G-I (for all of which assuming a sample with 140 mm by 140 mm dimensions and a cell size of 1.925 mm by 1.925 mm). FIG. 7G is a contour plot of the reflected beam strength (E-field) given by the numerical reflect array theory as a function of spherical angles θr, φr. FIG. 7H is a plot of the reflected beam strength (E-field) given by the numerical reflect array theory as a function of polar angle θr for φr=180°. FIG. 7I is a plot of the reflected beam strength (E-field) given by the numerical reflect array theory as a function of azimuthal angle or for θr=60°. For example, FIG. 7G depicts a contour plot, where this sample indeed generates a strong signal at θr=60°, φr=180° spherical angles. Note that for a symmetrical direction of θr=60°, φr=0°, no reflections are present, in accordance with the experimental data to be discussed further below. Finally, there is also a weak specular beam present, again in line with the experimental observations to be discussed further below.

### Examples 1 and 2

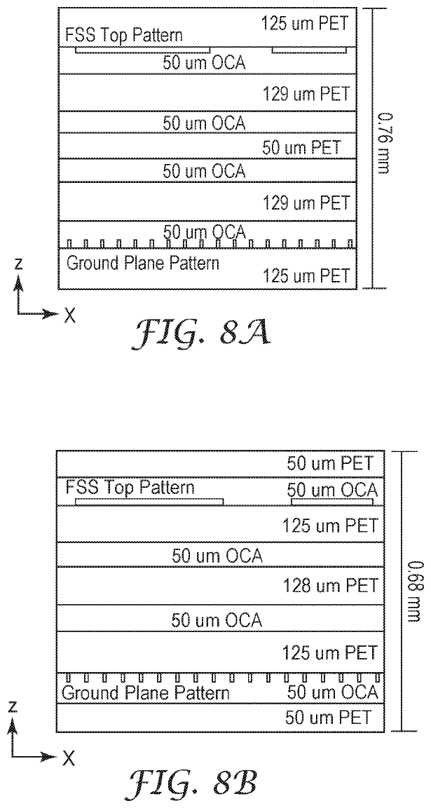

The laminated film cross sections for Example 1 (“0 to 60 degree array”) is shown in FIG. 8A. The laminated film cross sections for Example 2 (“0 to 39 degree array”) is shown in FIG. 8B. Example 1 has the total thickness of 0.76 mm and consists of the ground and FSS layers patterned on top of 125-micrometer-thick PET layers (which also serve as outer protection layers) that are separated by a dielectric laminate, which is made of two 129-micrometer-thick PET films and one 50 um PET film, all of which are separated by four layers of 50-micrometer-thick OCA. Example 2 has the total thickness of 0.68 mm and consists of the ground and FSS layers patterned on top of 125-micrometer-thick PET layers, which are turned inwards and separated by a dielectric stack made of one 128-micrometer-thick PET layer and two OCA layers. For outer protection of grounds and patterns, the extra 50-micrometer-thick PET and 50-micrometer-thick OCA layers are added on both sides of the stack.

Brief descriptions for Examples 1 and 2 are also listed in Table 1 below. The polyester terephthalate (PET) film is commercially available under the trade designation of MELINEX ST-504 from Tekra, New Berlin, WI. The optically clear adhesive (OCA) is commercially available under the trade designation of 3M 8212 optically clear adhesive from 3M Display Materials and Systems, Oakdale, MN.

TABLE 1

| Abbreviation | Description |
|---|---|
| Example 1 | Semi-transparent array that preferentially reflects a 30 |
| “0 to 60 degree | GHz RF beam from an incident direction normal (90 |
| array” | degrees) to the film plane to a direction that is 60 degrees |
| | from the normal direction (or 30 degrees from |
| | the film plane). Finished samples were 12.7 cm by 12.7 |
| | cm in dimension. |
| Example 2 | Semi-transparent array that preferentially reflects a 30.9 |
| “0 to 39 degree | GHz RF beam from an incident direction normal (90 |
| array” | degrees) to the film plane to a direction that is 39 degrees |
| | from the normal direction (or 51 degrees from |
| | the film plane). Finished samples were 12.7 cm by 12.7 |
| | cm in dimension. |

### Fabrication Steps

The following fabrication steps were the same for both examples A and B. Each example had two copper patterned layers; resonator structures in the form of a ring pattern, and a ground plane in the form of a uniform grid pattern. Film substrate was prepared by sputter coating a tie layer and copper seed layer onto an optical grade, heat stabilized PET film. The patterned resonator structures and ground plane grid patterns were prepared by electroplating the sputtered/seeded film substrate with 5 microns of copper. The exposed copper was then vacuum laminated with a layer of photoresist. The photoresist was exposed by laser direct imaging and then the unexposed regions were developed. The patterned photoresist served as a mask in a copper etching step using a cupric chloride etchant, followed by an electroless tin finish plating.

The functional reflectarray films were prepared by roll laminating interposing film layers between a patterned resonator film and a ground plane film using an optically clear adhesive (OCA). The ground plane mesh patterns for the 60-degree and 39-degree samples were identical. The mesh layer had a square repeat unit with a period of 192 microns and a trace width of 40 microns. The dimensions for resonating ring (labeled “a” through “f”) of Example 1 (the “0 to 60 degree array”), and resonating ring (labeled “a” through “h”) of Example 2 (the “0 to 39 degree array”) are given in the following Table 2. In both Examples, all rings have a trace width of 40 microns.

TABLE 2

| | Example 1 | Example 2 |
|---|---|---|
| Ring | Diameter (mm) | Diameter (mm) |
| a | 0.874 | 0.810 |
| b | 1.548 | 1.440 |
| c | 1.619 | 1.512 |
| d | 1.660 | 1.546 |
| e | 1.703 | 1.572 |
| f | 1.807 | 1.603 |
| g | | 1.651 |
| h | | 1.762 |

Each ring in the reflectarray unit cell has been assigned a specific diameter (listed in Table 2 for Examples 1 and 2) such that it generates a phase response that (as defined up to an arbitrary additive constant) incrementally increases from 360/n degrees for the first ring (which is 360/6=60 degrees for Example 1 and 360/8=45 degrees for Example 2) up to 360 degrees for the last ring of the unit cell, where n is the number of rings in the unit cell. This translates to the phase gradient of 311.7 deg/cm for Example 1 and 237.1 deg/cm for Example 2 (this, in turn, translates to the lattice periods of dx=6 dy, dy=1.925 mm for Example 1 and dx=8 dy, dy=1.898 mm for Example 2). Finally, using the Generalized Snell's Law, sin(θr)=sin(θi)+grad(φ)*λ/2π, for the operating frequencies of 30 GHz (Example 1) and 31.1 GHz (Example 2), this leads to the 0 to 60 degrees (Example 1) and 0 to 39 degrees (Example 2) beam steering performance.

### Characterization

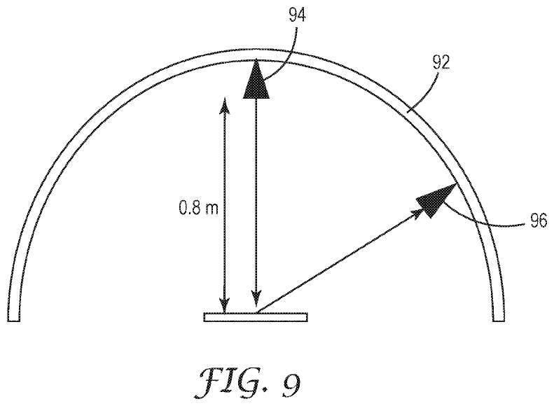

The beam steering performance of various reflectarray films of Examples 1 and 2, and a 5″ RF mirror were characterized using a custom-built arc setup as shown in FIG. 9. The RF mirror is a 38-micrometer thick aluminum foil glued on top of 5-micrometer thick foam. As shown in FIG. 9, the arc 92 consists of a semi-circle having a 0.8-meter radius. Transmitter and receiver horn antennas 94, 96 were independently positioned at various angles along the arc 92 to record reflected beam intensity as a function of frequency. The transmitter and receiver horns 94, 96 were ERAVANT WR-28 Standard Gain Horn Antennas. They were connected to the two ports of a vector network analyzer (Agilent Technologies E836C).

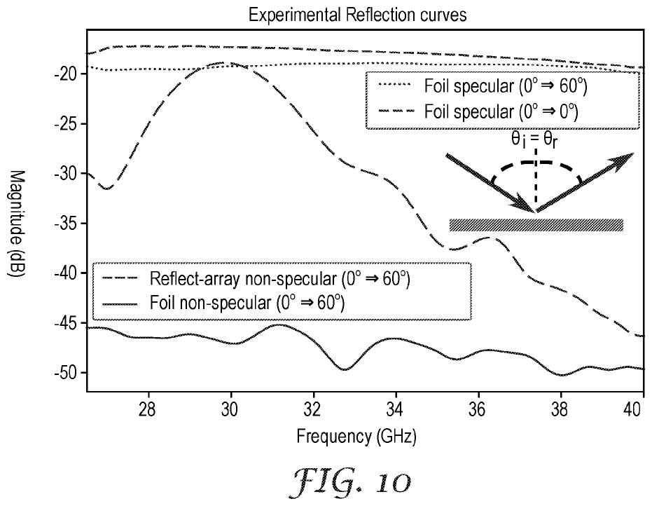

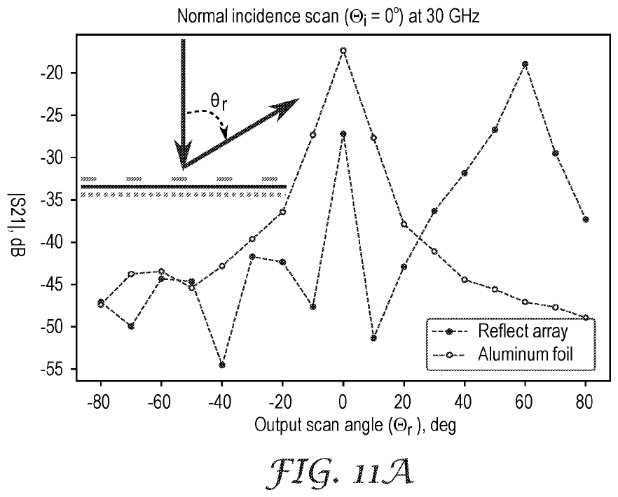

FIG. 10 is a plot of reflectance spectrum for the reflectarray film of Example 1 and for aluminum foil (in both non-specular and specular geometries). As shown in FIG. 10, the reflection of the sample in 0° to 60° off-specular geometry peaks at around 30 GHz, in full agreement with the design expectations discussed further above. The reflection magnitude is 19 dB, which is more than 25 dB higher than that of the RF mirror in the same off-specular geometry. Such off-specular reflection performance of the array compares well even with the specular performance of the foil, exceeding it for θᵣ=60°, while being just 1-2 dB lower at θᵣ=0°. The resulting bandwidth of the peak is about 2-3 GHz, which should be in line with typical requirements for mm-wave communications (e.g., for n260, n261 bands).

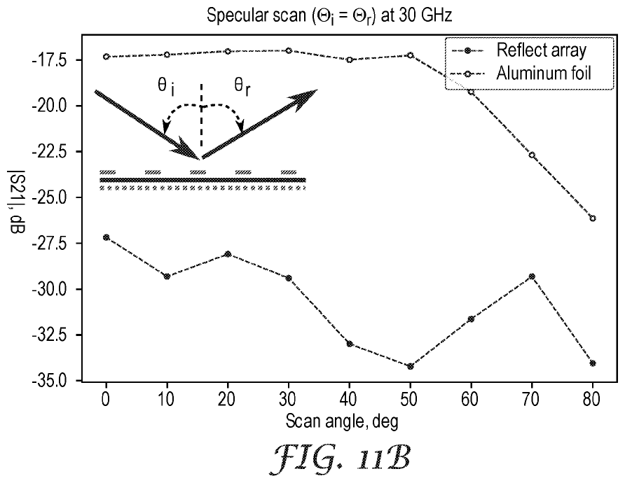

Since the designed exemplary reflect array demonstrates its peak performance at 30 GHz, the corresponding reflection performance for both non-specular and specular geometry scans can be compared. FIG. 11A is a plot of non-specular reflection curves for the reflectarray film of Example 1 and for aluminum foil at 30 GHz assuming a normally incident beam (the scan of Or while θi=0). FIG. 11A shows the result of scanning the output angle in the range from −80° to +80° when an incident angle is fixed to 0°. First, one can find that the sample steers the beam only to a single direction of θᵣ=+60°, with no signal present at θᵣ=−60°. However, in addition to this non-specular direction, the reflectarray sample also exhibits a minor specular (θr=0°) peak (that is 10 dB lower in magnitude). This means that the specular energy leakage is relatively weak, so the arrays produce an efficient beam steering. A specular reflection scan was performed, and the results are depicted in FIG. 11B. FIG. 11B is a plot of specular reflection curves for the reflectarray film of Example 1 and for aluminum foil at 30 GHz (the scan of θr while θi=θr). The specular performance of the reflectarray film is indeed weaker than that of a foil sample (by about 10 dB for all scan angles). Such specular reflections originate from the deviations in actual phase responses of resonating elements as well as from the contributions of the ground planes of reflect arrays (see J. Budhu, & Y. Rahmat-Samii, Y., IEEE International Symposium on Antennas and Propagation 97-100 (2011)).

1. An optically transparent reflectarray article comprising:
a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure;
a ground plane layer comprising a patterned conductor formed by a plurality of traces defining cells of a continuous metallic mesh disposed on a major surface thereof; and
one or more dielectric layers sandwiched between the FSS layer and the ground plane layer,
wherein the article is substantially optically transparent in a free-space wavelength range from about 380 nm to about 700 nm.

2. The article of claim 1, wherein the resonating metallic elements each have a lateral dimension no greater than the free-space wavelength 2.

3. The article of claim 2, wherein the resonating metallic elements each have a lateral dimension in a range from about 10 to about 10,000 micrometers.

4. The article of claim 1, wherein the resonating metallic elements each have a line width in a range from about 1.0 to about 50.0 micrometers.

5. The article of claim 1, wherein the resonating metallic elements comprises an array of periodic metastructures, optionally, comprising at least one of rings, or crosses.

6. The article of claim 1, wherein the traces of the metallic mesh have a line width in a range from about 1.0 to about 50.0 micrometers.

7. The article of claim 1, wherein the continuous metallic mesh has an open area fraction no less than about 50%.

8. The article of claim 1, wherein the patterned conductor has a sheet resistance no greater than about 1000 ohms per square.

9. The article of claim 1, wherein the FSS layer further comprises a flexible skin layer, and the pattern of resonating metallic elements is disposed between the skin layer and the one or more dielectric layers.

10. The article of claim 9, wherein the flexible skin layer has a thickness in a range from about 10 to about 500 micrometers.

11. The article of claim 9, wherein the flexible skin layer comprises a hardcoat layer or a polymeric encapsulating layer.

12. The article of claim 1, wherein the ground plane layer comprises a flexible layer, and the metallic mesh is disposed on an inner surface of the flexible layer.

13. The article of claim 12, wherein the flexible layer has a thickness in a range from about 10 to about 500 micrometers.

14. The article of claim 1, wherein the ground plane layer further comprises a tie layer disposed between the metallic mesh and the major surface thereof, the tie layer comprising at least one of chromium, chromium oxide, nickel chromium oxide, or combinations thereof.

15. The article of claim 1, wherein the one or more dielectric layers comprise an optically transparent polymer, optionally, the polymer comprising at least one of polyethylene terephthalate (PET), polyethylene naphthalate (PEN), acrylic-, butyrate-, polycarbonate, polycarbonate copolymers, polyethersulfone, or polyethylene terephthalate glycol-modified (PETG).

16. The article of claim 1, wherein the one or more dielectric layers have a thickness in a range from about 10 to about 1000 micrometers.

17. The article of claim 1, wherein the FSS layer and the ground plane layer are laminated to the one or more dielectric layers via an optically clear adhesive (OCA).

18. A method of making an optically transparent reflectarray article, the method comprising:
providing a frequency selective surface (FSS) layer comprising a pattern of resonating metallic elements configured to reflect an incident radiofrequency (RF) electromagnetic wave at a free-space wavelength λ in a range from about 1.0 mm to about 10.0 cm, each resonating metallic element comprising a wire-like structure;
providing a ground plane layer comprising a patterned conductor formed by a plurality of traces defining cells of a continuous metallic mesh disposed on a major surface thereof; and
providing a dielectric substrate comprising one or more dielectric layers sandwiched between the FSS layer and the ground plane layer,
wherein the article is substantially optically transparent in a free-space wavelength range from about 380 nm to about 700 nm.

19. The method of claim 18, wherein providing the FSS layer comprises forming the pattern of resonating metallic elements on a flexible skin layer, and laminating the flexible skin layer on the dielectric substrate.

20. The method of claim 18, wherein providing the ground plane layer comprises forming the metallic mesh on a flexible layer, and laminating the flexible layer on the dielectric substrate.
